(19) United States
(12) Patent Application Publication
(10) Pub. No.: US 2006/0125696 A1
(43) Pub. Date: Jun. 15, 2006

(54) Radio frequency antenna in a wireless device

(75) Inventors: Anthony Kerselaers, Leuven (BE); Edwin Jan Maria Van De Vonder, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/559,561

(22) PCT Filed: May 27, 2004
(86) PCT No.: PCT/IB04/50786

§ 371 Date: Dec. 2, 2005

(30) Foreign Application Priority Data
Jun. 6, 2003 (EP) 03101664.5

(51) Int. Cl. H01Q 1/38

(52) U.S. Cl. 343/700 MS

(57) ABSTRACT

Devices (1) comprising antenna (24, or 2, 3, 5) for receiving radio frequency signals are provided with first conductor (2) for receiving the radio frequency signals and for converting the radio frequency signals into electromagnetic fields and second conductor (3) for receiving at least a part of the electromagnetic fields and for converting the received electromagnetic fields into input signals. The second conductor (3) are coupled to radio frequency circuits (10) for processing the input signals. The resonant frequencies of these antennas (24, or 2, 3, 5) can be selected by designing the dimensions of the second conductor (3) and their positions with respect to the first conductor (2). The radio frequency circuits (10) comprise antenna diversity units (20) coupled to the second conductors (3) and to third conductors (4, 5). The third conductor (4) mainly receive the electromagnetic fields, or the third conductor (5) mainly receive the radio frequency signals. The devices (1) comprise wireless headphones.

The invention relates to a device comprising an antenna for receiving radio frequency signals, and also relates to an antenna, and to a method.

Examples of such a device are wireless headphone devices, mobile terminals and wireless interfaces.

A prior art antenna is known from US 2002/0177416 A1, which discloses a ground conductor incorporating a slot. To enable the ground conductor to function as an antenna, a transceiver is coupled to the slot The ground conductor, the slot and the transceiver are integrated in a module. The ground conductor is coupled to a further ground conductor in the form of a printed circuit board. By varying the area of the connections between the module and the further ground conductor, the resonant frequency of the slot can be modified. The antenna performs relatively well in a frequency band situated around this resonant frequency.

The known antenna is disadvantageous, inter alia, owing to the fact that the resonant frequency of the slot is to selected by designing the area of the connections between the module and the further ground conductor.

It is an object of the invention, inter alia, to provide a device comprising an antenne, whereby the resonant frequency can be selected without needing two ground conductors.

Furthers objects of the invention are, inter alia, to provide an antenna, whereby the resonant frequency can be selected without needing two ground conductors, and a method for use in combination with an antenna, whereby the resonant frequency can be selected without needing two ground conductors.

The device according to the invention comprises an antenne for receiving radio frequency signals, which antenne comprises:

a first conductor for receiving the radio frequency signals and for converting the radio frequency signals into electromagnetic fields; and

a second conductor for receiving at least a part of the electromagnetic fields and for converting the received electromagnetic fields into input signals, which second conductor is different from the first conductor and is coupled to a radio frequency circuit for processing the input signals.

The first conductor receives the radio frequency signals and converts the radio frequency signals into for example first currents, which first currents result in electromagnetic fields. The second conductor receives at least a part of the electromagnetic fields and converts the received electromagnetic fields into input signals such as for example second currents. These second currents are supplied to the radio frequency circuit for being processed. This processing for example comprises filtering, amplifying, mixing, detecting etc. So, the second conductor is mainly used for coupling the radio frequency signals as received by the first conductor into the radio frequency circuit Of course, it is unavoidable that the second conductor will also directly receive some of the radio frequency signals without the first conductor being involved. Therefore, the word “mainly” here means that at least 60% of the signals picked up by the second conductor originate from the first conductor.

The resonant frequency of this antenna can be selected by designing the dimensions of the second conductor and its position with respect to the first conductor. So, the resonant frequency of this antenna does not need to be selected by designing the area of the connections between the ground conductor and the further ground conductor, and the antenna according to the invention can be made more compact. Further, the prior art module needs to be enclosed in a conducting container. The antenna according to the invention can be used in a non-conducting container as well.

The device for example further comprises loudspeakers. The radio frequency signals are for example situated between 850 MHz and 950 MHz. Of course, the radio frequency signals comprise further electromagnetic fields, and the electromagnetic fields comprise further radio frequency signals. So, alternatively, one could speak of first and second radio frequency signals, or of first and second electromagnetic fields, or of first and second electromagnetic signals, etc.

An embodiment of the device according to the invention is defined by the radio frequency circuit comprising an antenna diversity unit comprising a first input coupled to the second conductor and a second input coupled to a third conductor of the antenne, which third conductor is different from the first and second conductors. The use of an antenna diversity circuit improves the performance of the antenna.

An embodiment of the device according to the invention is defined by the third conductor being mainly arranged for receiving at least a part of the electromagnetic fields. In this case, the second and third conductor are both used for coupling the radio frequency signals as received by the first conductor into the radio frequency circuit. Of course, it is unavoidable that the third conductor will also directly receive some of the radio frequency signals without the first conductor being involved. Therefore, the word “mainly” here means that at least 60% of the signals picked up by the third conductor originate from the first conductor.

An embodiment of the device according to the invention is defined by the third conductor being mainly arranged for receiving the radio frequency signals. In this case, the second conductor is used for coupling the radio frequency signals as received by the first conductor into the radio frequency circuit. The third conductor is used for directly receiving some of the radio frequency signals without the first conductor being involved. In other words, this antenna comprises two sub-antennas, a first sub-antenna comprising the first and second conductors, and a second sub-antenna comprising the third conductor. Of course, it is unavoidable that the third conductor will also receive some of the electromagnetic fields coming from the first conductor. Therefore, the word “mainly” here means that at least 60% of the signals picked up by the third conductor do not originate from the first conductor.

An embodiment of the device according to the invention is defined by the antenna diversity circuit comprising:

a first attenuator coupled to the first input;

a second attenuator coupled to the second input; and

a combiner comprising inputs coupled to outputs of the first and second attenuators.

The first attenuator attenuates the input signals coming from the second conductor or passes them unattenuatedly by setting the first attenuator to 0 dB or by short circuiting the first attenuator via a switch. The second attenuator attenuates input signals coming from the third conductor or passes them unattenuatedly by setting the second attenuator to 0 dB or by short circuiting the second attenuator via a switch. The combiner combines the possibly attenuated input signals. The attenuation of the attenuators may be adjustable.

An embodiment of the device according to the invention is defined by the radio frequency circuit being mounted on the first conductor. This allows the device to be made most compact.

An embodiment of the device according to the invention is defined by the first conductor being in the form of a plane having a first surface and the second conductor is in the form of a wire having a second surface smaller than the first surface. The plane having the largest surface such as for example a printed circuit board is used for picking up the radio frequency signals, and the wire or a wire-like trace of a printed circuit board is used for picking up the electromagnetic fields. The fact that the first conductor coincides with the printed circuit board is, compared to the prior art situation where the ground conductor is mounted on the printed circuit board, efficient and thus advantageous.

An embodiment of the device according to the invention is defined by the perimeter of the first conductor having a value between 15% of the wavelength of the radio frequency signals and 200% of the wavelength of the radio frequency signals. This antenna performs best.

An embodiment of the device according to the invention is defined by the first conductor being substantially a square. This antenna is most compact The word “substantially” here means that the difference in length between two sides of the first conductor is at most 20% of one of the sides.

An embodiment of the device according to the invention is defined by the second conductor being substantially located in parallel to a side of the first conductor, which first and second conductor are separated from each other by an air gap having a gap distance smaller than the length of the side of the first conductor. The resonant frequency of this antenna can be selected by designing the length of the second conductor and the gap distance.

The device according to the invention for example comprises a wireless headphone with a headband, wherein the radio frequency circuit comprises an antenna diversity unit comprising a first input coupled to the second conductor and a second input coupled to a third conductor of the antenne, which third conductor is mainly arranged for receiving the radio frequency signals from the other device, and which third conductor forms part of the headband, the first conductor being in the form of a plane having a first surface and the second conductor being in the form of a wire having a second surface smaller than the first surface, the second conductor being substantially located in parallel to a side of the first conductor, which first and second conductor are separated from each other by an air gap having a gap distance smaller than the length of the side of the first conductor, and which first and second conductor are substantially located in a further plane (the word “substantially” here corresponds with plus/minus at most a thickness of a conductor), which further plane is substantially located in parallel to a head of a person wearing the headphone (the word “substantially” here corresponds with plus/minus at most thirty degrees).

Embodiments of the antenna according to the invention and of the method according to the invention correspond with the embodiments of the device according to the invention.

The invention is based upon an insight, inter alia, that it is disadvantageous to need two different ground conductors (planes) to define a resonant frequency, and is based upon a basic idea, inter alia, that a resonant frequency can be defined by positioning two conductors with respect to each other, whereby one of the conductors is used for receiving the radio frequency signals and the other conductor is used for coupling the radio frequency signals as received by the first conductor into the radio frequency circuit.

The invention solves the problem, inter alia, to provide a device comprising an antenne, whereby the resonant frequency can be selected without needing two ground conductors, and is advantageous, inter alia, in that the antenne is compact and has a good performance even when being used in the vicinity of a person's head.

These and other aspects of the invention will be apparent from and elucidated with reference to the embodiment(s) described hereinafter.

In the drawings:

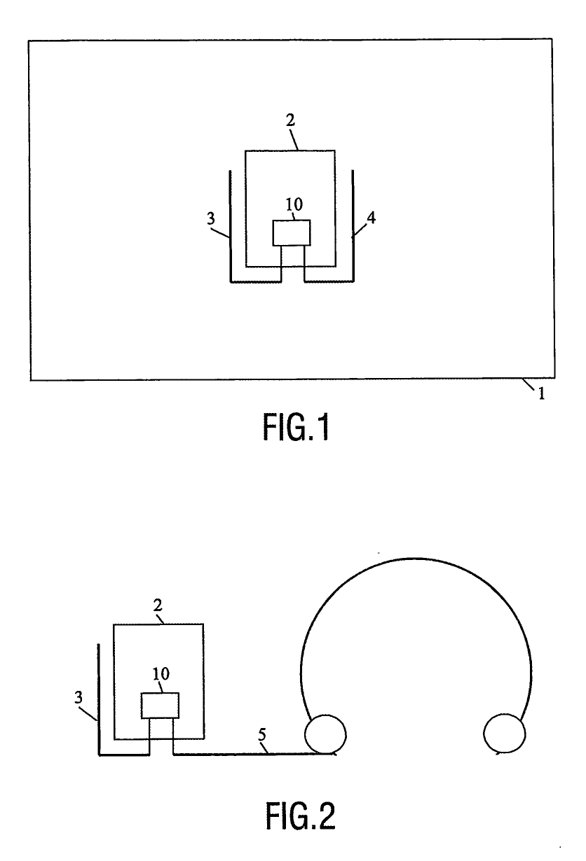

FIG. 1 shows diagrammatically a device according to the invention comprising an antenna according to the invention;

FIG. 2 shows diagrammatically an antenna according to the invention comprising a first sub-antenna and a second sub-antenna;

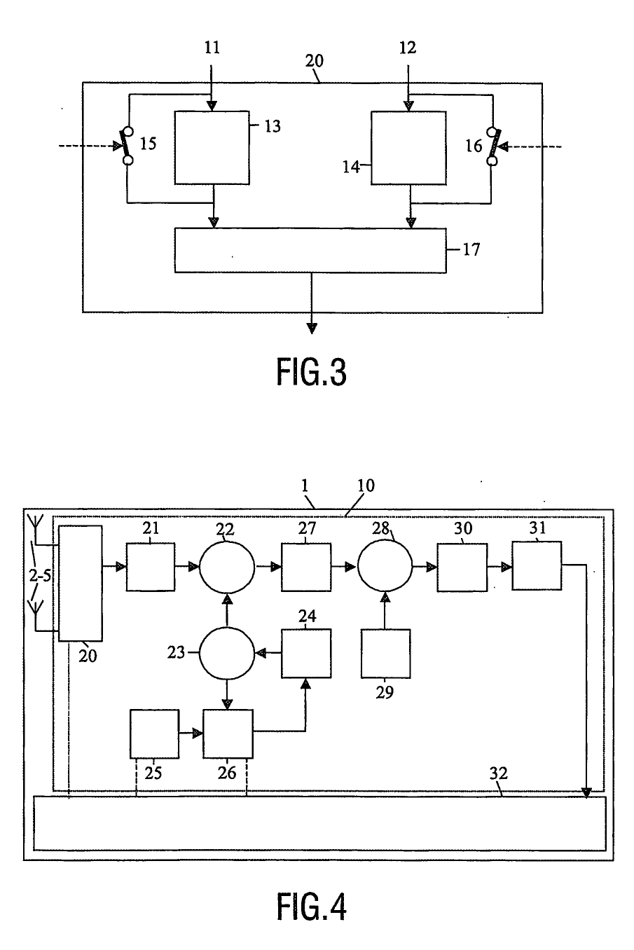

FIG. 3 shows diagrammatically an antenna diversity unit to be coupled to an antenna according to the invention;

FIG. 4 shows diagrammatically a device according to the invention comprising an antenna according to the invention and a radio frequency circuit;

FIG. 5 shows a return loss for the antenna according to the invention shown in FIG. 1 as measured on the second conductor;

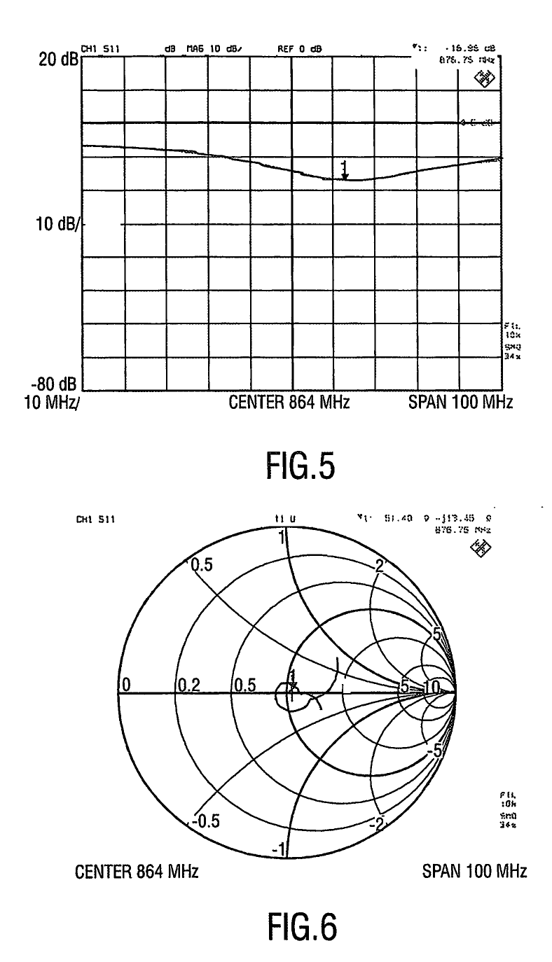

FIG. 6 shows an impedance of the antenna according to the invention shown in FIG. 1 as measured on the second conductor;

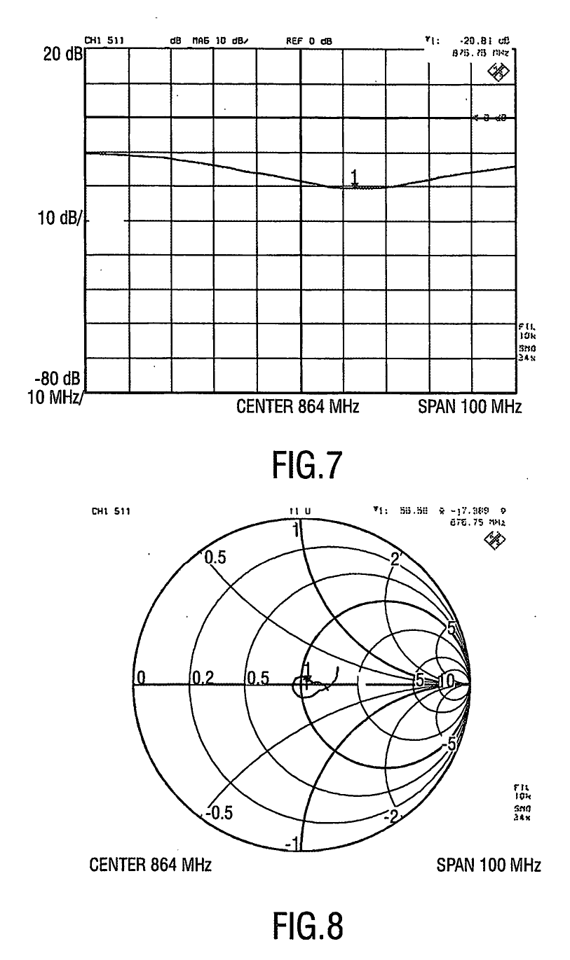

FIG. 7 shows a return loss for the antenna according to the invention shown in FIG. 1 as measured on the third conductor;

FIG. 8 shows an impedance of the antenna according to the invention shown in FIG. 1 as measured on the third conductor; and

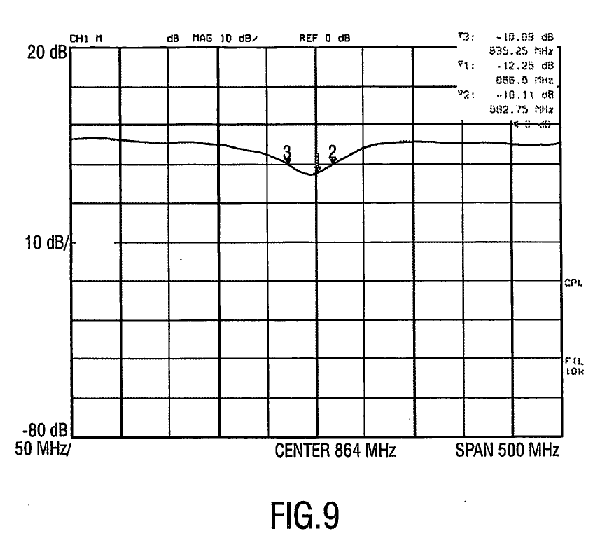

FIG. 9 shows a return loss for the antenna according to the invention shown in FIG. 2 as measured on the second conductor.

The device 1 according to the invention shown in FIG. 1 comprises an antenna 2-4 according to the invention. The antenna 2-4 comprises a first conductor 2, a second conductor 3 and a third conductor 4. A radio frequency circuit 10 for example comprising an antenna diversity unit is mounted on the first conductor 2. The first conductor 2 is for example in the form of a plane having a first surface and the second conductor 3 and the third conductor 4 are for example in the form of wires having second surfaces smaller than the first surface. Preferably, the perimeter of the first conductor 2 has a value between half the wavelength of the radio frequency signals to be received and twice the wavelength of the radio frequency signals to be received. The first conductor 2 may be a square. The second conductor 3 and the third conductor 4 are located in parallel to a side of the first conductor 2 and are separated by air gaps from the first conductor 3. These air gaps have gap distances smaller than the length of the side of the first conductor 2. The second conductor 3 and the third conductor 4 may be located in the same plane as the first conductor 2.

The antenna 2-4 shown in FIG. 1 operates as follows. The first conductor 2 receives the radio frequency signals and converts the radio frequency signals into for example first currents, which first currents result in electromagnetic fields. The second conductor 3 and the third conductor 4 receive at least parts of the electromagnetic fields and convert the received electromagnetic fields into input signals such as for example second currents. These second currents are supplied to the radio frequency circuit 10 for being processed, as further described for FIG. 3. So, the second conductor 3 and the third conductor 4 are mainly used for coupling the radio frequency signals as received by the first conductor 2 into the radio frequency circuit 10.

The resonant frequency of this antenna 2-4 can be selected by designing the dimensions (lengths, diameter) of the second conductor 3 and the third conductor 4 and their positions (gap distances) with respect to the first conductor 2.

The device for example further comprises loudspeakers. The radio frequency signals are for example situated between 850 MHz and 950 MHz.

The antenna 2,3,5 according to the invention shown in FIG. 2 comprises a first sub-antenna 2,3 and a second sub-antenna 5. The antenna 2,3,5 corresponds with the antenna 2-4 shown in FIG. 1, apart from the fact that the third conductor 5 in this case forms part of a headband of a wireless headphone.

The antenna 2,3,5 shown in FIG. 2 operates in accordance with the operation of the antenna 2-4 already described, apart from the fact that the third conductor 4 now receives the radio frequency signals, just like the first conductor 2. So, in this case, the third conductor 4 is, contrary to the second conductor 3, this time not used for coupling the radio frequency signals as received by the first conductor 2 into the radio frequency circuit 10.

Of course, in a minimum configuration, the antenne 2,3 only comprises the first conductor 2 and the second conductor 3, in which case the radio frequency circuit 10 will not comprise an antenna diversity unit.

The antenna diversity unit 20 as shown in FIG. 3 comprises a first input 11 coupled to the second conductor 3 and a second input 12 coupled to the third conductor 4,5. The use of such an antenna diversity circuit improves the performance of the antenna 2-5. The antenna diversity circuit 20 comprises a first attenuator 13 coupled to the first input 11 and a second attenuator 14 coupled to the second input 12 and a combiner 17 comprising inputs coupled to outputs of the first and second attenuators 13,14. The first attenuator 13 attenuates the input signals coming from the second conductor 2 or passes them unattenuatedly by setting the first attenuator to 0 dB or by short circuiting the first attenuator 13 via a switch 15. The second attenuator 14 attenuates input signals coming from the third conductor 4,5 or passes them unattenuatedly by setting the second attenuator 14 to 0 dB or by short circuiting the second attenuator 14 via a switch 16. The combiner 17 combines the possibly attenuated input signals. The attenuation of the attenuators 13,14 may be adjustable.

The device 1 according to the invention shown in FIG. 4 comprises an antenna 2-5 according to the invention and a radio frequency circuit 10. This radio frequency circuit 10 comprises the antenna diversity unit 20 coupled to the antenna 2-5 and to a unit 21 comprising a SAW filter and a low noise amplifier. The unit 21 is coupled to a mixer 22, which is further coupled to an oscillator 23 and to a unit 27 comprising a band pass filter and an intermediate frequency amplifier and a further band pass filter and a linear amplifier. The oscillator 23 is coupled to a low pass filter 24 and to a synthesizer 26, which synthesizer 26 is coupled to the low pass filter 24 and to a controller 25. The unit 27 is further coupled to a detector 28, which is further coupled to a reference unit 29 and to a unit 30 comprising a buffer amplifier and a Gaussian filter. The unit 30 is further coupled to a slicer 31, which is coupled to a processor system 32. This processor system 32 comprises a processor and a memory not shown and is further coupled to the units 20, 25 and 26 and to a man-machine-interface not shown.

The operation of the device 1 shown in FIG. 4 is common in the art, apart from the operation of the antenna 2-5 and the operation of the antenna diversity unit 20. In response to for example error detections and/or amplitude measurements and/or power measurements, the processor system 32 controls the antenna diversity unit 20 for controlling adjusting the attenuators 13,14 and/or the switches 15,16. As a result, the signals received via the second conductor 3 are made more important than the signals received via the third conductor 4,5, or vice versa.

In FIG. 5, a return loss is shown for the antenna according to the invention shown in FIG. 1 as measured on the second conductor, in dB (y-axis) versus MHz (x-axis).

In FIG. 6 an impedance is shown of the antenna according to the invention shown in FIG. 1 as measured on the second conductor.

In FIG. 7 a return loss is shown for the antenna according to the invention shown in FIG. 1 as measured on the third conductor, in dB (y-axis) versus MHz (x-axis).

In FIG. 8, an impedance is shown of the antenna according to the invention shown in FIG. 1 as measured on the third conductor.

In FIG. 9, a return loss is shown for the antenna according to the invention shown in FIG. 2 as measured on the second conductor, in dB -axis) versus MHz (x-axis).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. Device (1) comprising an antenne for receiving radio frequency signals, which antenne.(2-5) comprises:
a first conductor (2) for receiving the radio frequency signals and for converting the radio frequency signals into electromagnetic fields; and
a second conductor (3) for receiving at least a part of the electromagnetic fields and for converting the received electromagnetic fields into input signals, which second conductor (3) is different from the first conductor (2) and is coupled to a radio frequency circuit (10) for processing the input signals.

2. Device (1) according to claim 1, wherein the radio frequency circuit (10) comprises an antenna diversity unit (20) comprising a first input (11) coupled to the second conductor (3) and a second input (12) coupled to a third conductor (4,5) of the antenne (2-5), which third conductor (4,5) is different from the first (2) and second (3) conductors.

3. Device (1) according to claim 2, wherein the third conductor (4) is mainly arranged for receiving at least a part of the electromagnetic fields.

4. Device (1) according to claim 2, wherein the third conductor (5) is mainly arranged for receiving the radio frequency signals.

5. Device (1) according to claim 2, wherein the antenna diversity circuit comprises:
a first attenuator (13) coupled to the first input (11);
a second attenuator (14) coupled to the second input (12); and
a combiner (17) comprising inputs coupled to outputs of the first and second attenuators (13,14).

6. Device (1) according to claim 1, wherein the radio frequency circuit (10) is mounted on the first conductor (2).

7. Device (1) according to claim 1, wherein the first conductor (2) is in the form of a plane having a first surface and the second conductor (3) is in the form of a wire having a second surface smaller than the first surface.

8. Device (1) according to claim 7, wherein the perimeter of the first conductor (2) has a value between 15% of the wavelength of the radio frequency signals and 200% of the wavelength of the radio frequency signals.

9. Device (1) according to claim 7, wherein the first conductor (2) is substantially a square.

10. Device (1) according to claim 7, wherein the second conductor (3) is substantially located in parallel to a side of the first conductor (2), which first (2) and second (3) conductor are separated from each other by an air gap having a gap distance smaller than the length of the side of the first conductor (2).

11. Antenne (2-5) for receiving radio frequency signals and comprising:
a first conductor (2) for receiving the radio frequency signals and for converting the radio frequency signals into electromagnetic fields; and
a second conductor (3) for receiving at least a part of the electromagnetic fields and for converting the received electromagnetic fields into input signals, which second conductor (3) is coupled to a radio frequency circuit (10) for processing the input signals.

12. Method for receiving radio frequency signals and comprising the steps of:
at a location, receiving the radio frequency signals and converting the radio frequency signals into electromagnetic fields;
at a different location, receiving at least a part of the electromagnetic fields and converting the received electromagnetic fields into input signals; and
processing the input signals.
